(19) United States
(12) Patent Application Publication
(10) Pub. No.: US 2007/0168083 A1
(43) Pub. Date: Jul. 19, 2007

(54) Method and apparatus for optimizing fossil fuel fired boiler burner combustion

(76) Inventors: Paul C. Thulen, Granby, CT (US); Hui Zhang, West Hartford, CT (US); Jianmin He, West Hartford, CT (US); Paul H. Chase, East Granby, CT (US)

Correspondence Address: Michael M. Rickin;ABB Inc., Legal Department - 4U6, 29801 Euclid Avenue, Wickliffe, OH, 44092-1832, US

(21) Appl. No.: 11/331,571

(22) Filed: Jan. 13, 2006

(51) Int. Cl. G05B 21/00

(52) U.S. Cl. 700/274

(57) ABSTRACT

Burner combustion of a fossil fuel fired boiler is optimized by using information about the combustion of each burner in the one or more groups of burners in the boiler. Controlled changes to certain combustion related manipulate variables selected for each burner are used with the combustion index for that burner to tune the combustion of each of the burners in each of the groups of burners to give a balanced combustion. Global objectives such as minimizing global NOx and CO emissions can also be achieved.

### FIELD OF THE INVENTION

This invention relates generally to the control of fossil fuel fired boilers, and more specifically to the optimization of the individual burner combustion and a reduction of the global combustion by-product formation rate by using a local estimation of the combustion quality in each individual burner.

### DESCRIPTION OF THE PRIOR ART

Due to the increased requirement of economic savings and environment protection, fossil fuel fired power plant control systems were continuously improved in order to increase the boiler operating efficiency and at the same time reduce global emissions, especially NOx emissions, generated from the combustion process. The prior art approaches to emission and boiler efficiency control use only the global average O₂, CO, NOx information from the flue gas analyzer to trim the combustion control system. The global average information provides very limited insight into the combustion condition inside each individual burner.

Though significant variations exist in the combustion process at each individual burner, such as fuel distribution imbalance, air distribution imbalance, fuel air mixture imbalance, fuel properties, etc., the boiler combustion control system has to keep most of the boiler settings constant and equal across groups of burners, due to the lack of individual burner combustion information. Thus the prior art optimization approach is significantly limited and inefficient since the combustion behavior of each individual burner is not observed.

In actual combustion, the fuel and air normally are not perfectly mixed in each individual burner. Therefore, additional combustion air, that is, an amount over the air that is theoretically needed if there was a perfect mixture of air and fuel, is furnished in order to assure complete combustion. Because the fuel and air are usually not uniformly distributed among the individual burners, the combustion control system, which controls the distribution of fuel and air for a group of burners based on the global average information obtained from the flue gas analyzer, is very conservative with respect to applying more air than the optimum amount. This control system limitation negatively affects the overall boiler efficiency and tends to generate more pollutants.

As is well known in the prior art, a flame analysis unit is usually mounted on each burner. The analysis unit is a safety device to monitor the flame stability by sensing the flame characteristics in the burner. If the local combustion information can be extracted from the existing flame analysis units, then this timely and detailed information of combustion for each individual burner can be supplied to the boiler control system to improve the boiler efficiency and reduce emissions without the cost of adding extra sensors. The present invention extracts the local combustion information and uses that information to optimize individual burner combustion and reduce the global combustion by-product formation rate.

### SUMMARY OF THE INVENTION

A computer program product for optimizing combustion in a fossil fuel fired boiler having one or more burners arranged in a group of burners, said computer program product comprising:

computer usable program code configured to permit for each of said one or more burners in said group of burners one or more combustion related manipulate variables to be selected for use in tuning the combustion of each of said one or more burners;

computer usable program code configured to provide a combustion index (CI) for each of said one or more burners; and

computer usable program code configured to use said CI and controlled changes in said one or more selected combustion related manipulate variables to tune the combustion of each of said one or more burners in said group of burners so that each of said one or more burners in said group achieves an associated maximum value of CI.

A system for optimizing fossil fuel fired burner combustion in a boiler, said boiler comprising one or more burners arranged in a group of burners, comprising:

a computing device having therein program code usable by said computing device, said program code configured to:

permit for each of said one or more burners in said group of burners one or more combustion related manipulate variables to be selected for use in tuning the combustion of each of said one or more burners;

provide a combustion index (CI) for each of said one or more burners; and

use said CI and controlled changes in said one or more selected combustion related manipulate variables to tune the combustion of each of said one or more burners in said group of burners so that each of said one or more burners in said group achieves an associated maximum value of CI.

A computer program product for optimizing combustion in a fossil fuel fired boiler having two or more groups of burners, each of said two or more groups of burners having one or more burners, said computer program product comprising:

computer usable program code configured to permit for each of said one or more burners in said two or more groups of burners one or more combustion related manipulate variables to be selected for use in tuning the combustion of each of said one or more burners in each of said two or more groups of burners;

computer usable program code configured to provide a CI for each of said one or more burners in each of said two or more groups of burners; and

computer usable program code configured to use said CI and controlled changes in said one or more selected combustion related manipulate variables to tune the combustion of each of said one or more burners in each of said two or more groups of burners so that each of said one or more burners in said two or more groups of burners achieves an associated maximum value of CI.

### DESCRIPTION OF THE DRAWING

FIG. 1 shows a fossil fuel fired boiler that has a multiplicity of burners.

FIG. 2 shows a curve of combustion index (CI) versus a manipulative variable (MV) at a constant load.

FIG. 3 shows a system that implements the optimization technique of the present invention.

### DETAILED DESCRIPTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, the present invention may take the form of a computer program product on a computer-usable or computer-readable medium having computer-usable program code embodied in the medium. The computer-usable or computer-readable medium may be any medium that can contain, store, communicate, propagate, or transport the program for use by or in connection with the instruction execution system, apparatus, or device and may by way of example but without limitation, be an electronic, magnetic, optical, electromagnetic, infrared, or semiconductor system, apparatus, device, or propagation medium or even be paper or other suitable medium upon which the program is printed. More specific examples (a non-exhaustive list) of the computer-readable medium would include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device may be.

Computer program code for carrying out operations of the present invention may be written in an object oriented programming language such as Java, Smalltalk, C++ or the like, or may also be written in conventional procedural programming languages, such as the “C” programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

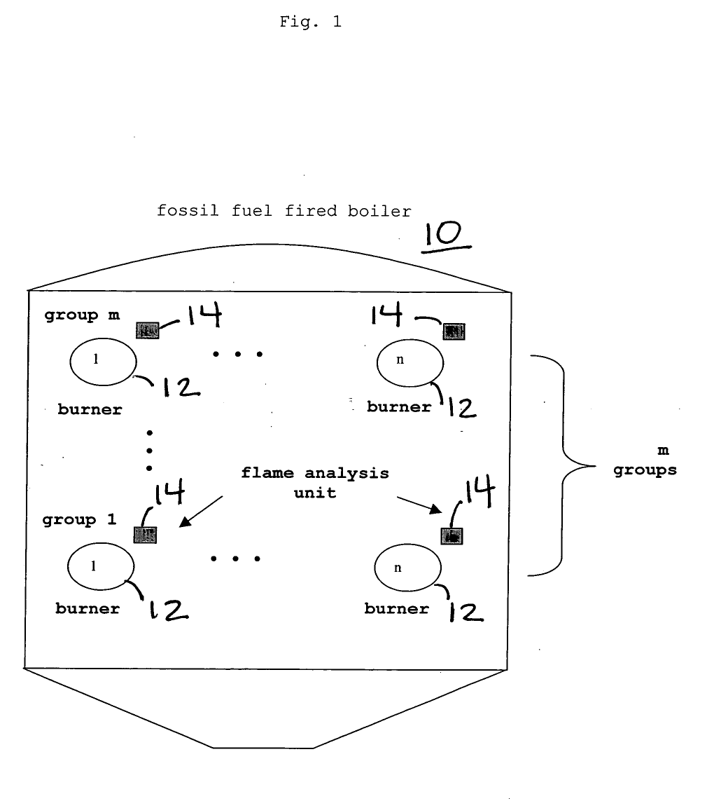

Referring now to FIG. 1, there is shown in simplified form a fossil fuel fired boiler 10 that has a multiplicity of burners 12. The burners 12 are arranged in m groups with n burners 12 in each group and each burner 12 has as is shown in FIG. 1 an associated flame analysis unit 14.

In accordance with the present invention, the method and apparatus described below is applied to a limited range of the flame electromagnetic spectrum sensed by each flame analysis unit 14 to extract, as is described in U.S. Published Application 20040033457 A1 published on Feb. 19, 2004 and entitled “Combustion Emission Estimation With Flame Sensing System”, the disclosure of which is hereby incorporated herein by reference, information that is referred to herein as a combustion index (CI). As is described in more detail below, the CI provides combustion turbulence information related to the fuel/air ratio in the combustion process in each burner and the CI is used to optimize the individual burner combustion process and the reduction of the global combustion by-product formation rate. Thus, in accordance with the present invention the local combustion information is used to optimize the combustion process in each burner and the global combustion by-product formation rate.

By using the CI, the combustion behavior can be tuned continuously for each individual burner by adjusting its air/fuel ratio to the desired fuel/air ratio. After balancing the individual combustion of each burner in the burner group, the combustion condition among groups of burners is altered, for example by fuel or air staging, to minimize the global combustion by-product generation rate, without violating the constraints on the overall boiler efficiency or load.

Before the optimization procedure of the present invention begins, manipulate variables (MVs), such as for example the secondary air flow, are chosen for adjusting the air/fuel distribution inside each burner 12 in the same burner group to optimize the burner combustion. Before the tuning process, MVs, such as the flow of the fuel, for example, coal or oil, necessary for tuning the combustion condition at a group level in order to meet global emission reduction requirements are also identified.

For the purpose of clarifying the description of the method of the present invention, the following notations are used:

CIᵢⱼ: the CI value for the j-th burner of the i-th group

| | |
|---|---|
| MVᵢⱼ: | the manipulate variable to adjust the air/fuel |
| | ratio for the j-th burner of the i-th group |
| GMVᵢ: | the group level combustion tuning manipulate |
| | variable for the i-th burner group |
| ΔGMVᵢ: | the pre-selected GMV step change increment for |
| | the i-th group, depending on load. |

The tuning of the combustion for each individual burner 12 is guided by the approximate steady state relationship between the MVs chosen for use in adjusting the air/fuel ratio of the combustion and the CI value of that individual burner. The procedure to tune the combustion for each individual burner 12 is:

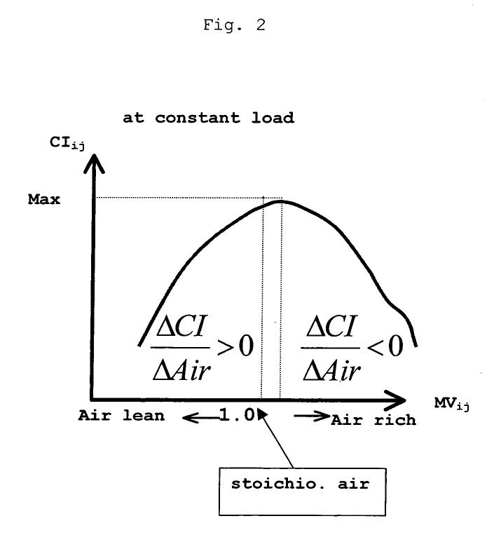

1. Adjust the air/fuel ratio of the local combustion by applying small step changes (e.g., 5% change each time) to the pre-selected manipulate variable (MVᵢⱼ) which is usually secondary air flow. After every MVᵢⱼ step change wait until any transient behavior has diminished and then record the steady state combustion index value (CIᵢⱼ). In this way, the CI vs. MV maps for all the individual burners at a specific load condition can be generated. The overall MVᵢⱼ change should be as dramatic as possible to cover a wide range of air/fuel conditions from air lean to air rich. The CIᵢⱼ vs. MVᵢⱼ map of every individual burner has for a constant load a curve similar to the curve shown in FIG. 2. The CIᵢⱼ increases with the increase of the air when the combustion is in an air lean condition, and the CIᵢⱼ decreases with the increase of the air when the combustion is in an air rich condition. For each burner, the maximum CI value is achieved when the air is a little more than the stoichiometry air, because the air and fuel are usually not perfectly mixed for the combustion. It should be noted that the maximum CI value is not the same among the burners of the same burner group because of the non-uniform fuel (coal or oil) distribution. The CI vs. MV maps of each burner are not the same at different load conditions, so they should be generated separately for all the load conditions (such as, high, medium, and low) typically associated with the fossil fuel fired boiler in which the burners are situated.

2. Based on the CI vs. MV map obtained during step 1, the MVᵢⱼ, usually secondary air flow, for every burner is changed to the value corresponding to the maximum CIᵢⱼ. Then the amount of air needed to accomplish an efficient combustion with respect to the fuel distributed to that specific burner is provided to the burner. Thus, the non-uniform fuel distribution problem can be solved with the burner level CI measurement.

After these first two steps, a balanced combustion is achieved for further optimization. The boiler operator can also choose the air/fuel ratio condition for the combustion of all the individual burners. For example, the combustion of the burners near the sidewalls may be set to an air rich condition to accommodate the slagging problem. The CIᵢⱼ and MVᵢⱼ, which correspond to the air rich condition, can be chosen, based on the curve shown in FIG. 2.

The steps 3 to 7 described below achieve additional global objectives (such as, but not limited to, minimizing global NOx and CO emissions) by altering the combustion condition at the group level (i.e., collectively for all the burners of the same burner group). The purpose of steps 3 to 7 is to search for an optimal set of GMVᵢ value to achieve a global optimal objective after the combustion is balanced via steps 1 and 2, described above.

For example, if the boiler operator wants to set the combustion of the burners in the group at the bottom elevation to an air lean condition in order to reduce global NOx, the operator can change all the MVs for those burners to the values, which are corresponding to the air lean combustion condition based on the maps generated in step 1. The boiler operator can also go through the guided-search process described below to achieve a global optimal objective.

The steps 3 to 7 are:

3. Change the nominal value of the manipulate variable of the i-th burner group GMVᵢ by ΔGMVᵢ, and wait until the steady state and then record the global objective value, such as minimal NOx or minimal CO or maximum fuel efficiency, if the boiler efficiency and all the other constraints are not violated.

4. Repeat step 3 for all the groups. The manipulate variable of the prior altered group should be restored to its nominal value before changing the manipulate variable of the current group.

5. If the minimal (or maximal) global objective is achieved at the nominal setup, then the searching process is stopped. This means that the optimal objective is achieved at the current set of the GMVi value. Otherwise the procedure continues with steps 6 and 7.

6. From the last achieved optimal situation, further change the i-th burner group GMVᵢ by ΔGMVᵢ, until the global objective does not decrease if the objective is to find a minimum or increase if the objective is to find a maximum or any violation of the constraints happens.

7. Repeat step 6 for all those groups, whose objective achieved in step 4 is less if the objective is to find a minimum or greater if the objective is to find a maximum than that achieved at the nominal setup.

By continuously adjusting the MVs inside and among the groups at a specific load condition, following the above procedures, the boiler will run under the balanced combustion condition with higher efficiency and with improved global combustion results.

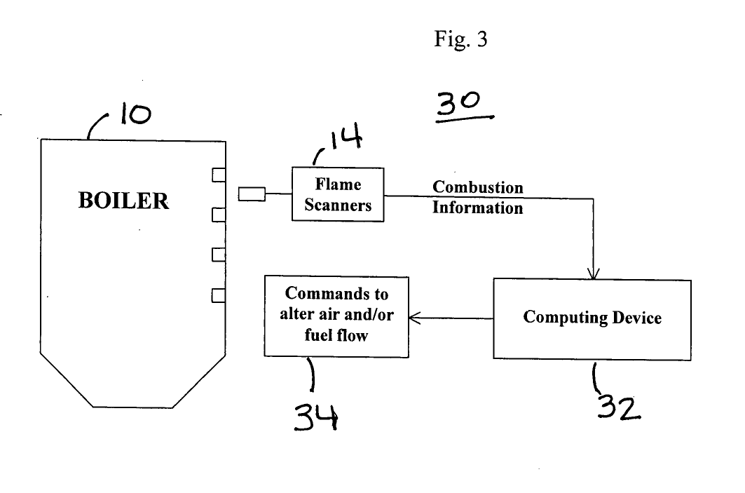

Referring now to FIG. 3, there is shown a system 30 which may be used to implement the optimization procedure of the present invention described above. The system 30 includes a computing device 32 in which a software program that implements the optimization procedure is stored. The software program includes all of the steps described above.

The computing device 32 may include the software program or the program may be resident, as described above, on media that interfaces with the device 32 such that the program can be loaded into the computing device 32 or the program may be downloaded, as described above, into the device 32 by well known means from the same site where device 32 is located or at another site that is remote from the site where device 32 is located.

The input to computing device 32 is from each of the flame scanners or flame analysis units 14, which as is described above, are associated with each of the n burners 12 in the m groups shown in FIG. 1. As is described above, the flame scanners 14 provide the computing device 32 with the combustion information which, as is described above, is used by the optimization procedure of the present invention. As is also described above, the procedure of the present invention which is resident in computing device 32 uses the combustion information to generate the commands 34 to alter the air and/or fuel flow to thereby the combustion in fossil fuel fired boiler 10.

It should be appreciated that the method of the present invention has two separate steps. Steps 1 and 2 described herein are used to tune the combustion for each burner in each group of burners to have the most efficient combustion. Steps 3 to 7 described herein are used to achieve the global objectives such as for example minimizing global NOx and CO emissions.

It should be further appreciated that the method of the present invention can be used for a fossil fuel fired boiler that only has a single burner in a single group. When used in such a boiler the first part of the method, that is steps 1 and 2, is different from controlling the fuel and air to the single burner since steps 1 and 2 use the combustion index (CI) to determine the maximum CI for the burner which is equivalent to determining the best combustion efficiency for the single burner. Thus these steps are a closed loop technique that can compensate for parameters other than fuel or air such as for example coal moisture variation or air pipe leakage.

While the maximum CI determined using steps 1 and 2 will give the best combustion efficiency for the single burner, it may not give good emissions, for example lower NOx, from that burner. Thus it should also be further appreciated that when the method of the present invention is used in a single burner boiler, steps 3 to 7 can be used to find the CI that corresponds to the desired level of controlled emissions, for example, lower NOx from the combustion at the single burner. For example, as a result of steps 3 to 7, the CI for the single burner is set to a value for a lean air condition to thereby help lower the NOx.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A computer program product for optimizing combustion in a fossil fuel fired boiler having one or more burners arranged in a group of burners, said computer program product comprising:
computer usable program code configured to permit for each of said one or more burners in said group of burners one or more combustion related manipulate variables to be selected for use in tuning the combustion of each of said one or more burners;
computer usable program code configured to provide a combustion index (CI) for each of said one or more burners; and
computer usable program code configured to use said CI and controlled changes in said one or more selected combustion related manipulate variables to tune the combustion of each of said one or more burners in said group of burners so that each of said one or more burners in said group achieves an associated maximum value of CI.

2. The computer program product of claim 1 where said fossil fuel fired boiler has one or more other groups of burners, each of said other groups of burners having one or more burners, and said computer program product further comprises:
computer usable program code configured to permit for each of said one or more burners in said one or more other groups of burners one or more combustion related manipulate variables to be selected for use in tuning the combustion of each of said one or more burners in each of said one or more other groups;
computer usable program code configured to provide a CI for each of said one or more burners in each of said one or more other groups; and
computer usable program code configured to use said CI and controlled changes in said one or more selected combustion related manipulate variables to tune the combustion of each of said one or more burners in each of said one or more other groups so that each of said one or more burners in said one or more other groups achieves an associated maximum value of CI.

3. The computer program product of claim 1 further comprising:
computer usable program code configured to determine for each of said one or more burners a value of said CI that corresponds to a desired level of controlled emissions from said fossil fuel fired boiler.

4. The computer program product of claim 2 further comprising:
computer usable program code configured to determine for each of said one or more burners in said group of burners and each of said one or more burners in said other groups of burners a value of said CI that corresponds to a desired level of controlled emissions from said fossil fuel fired boiler.

5. The computer program product of claim 1 further comprising computer usable code configured to map for each of said one or more burners in said group of burners said associated CI resulting from each of said controlled changes in said one or more selected combustion related manipulate variables when said CI has reached a steady state versus said one or more selected combustion related manipulate variables.

6. The computer program product of claim 5 further comprising computer usable code configured to use said map for each of said one or more burners in said group of burners to achieve said associated maximum value of CI.

7. The computer program product of claim 1 further comprising computer usable code configured to allow said tuned combustion for all of said one or more burners in said group of burners to be changed to achieve other than said associated maximum value of CI for each of said one or more burners.

8. The computer program product of claim 1 wherein each of said one or more selected combustion related manipulate variables has a value for said group of burners corresponding to said combustion for all of said one or more burners in said group that achieves said associated value of CI and said computer program product further comprises computer usable code configured to allow said value to be changed by a predetermined amount in order to achieve a predetermined optimal objective value for operation of said boiler.

9. The computer program product of claim 8 further comprising computer usable code configured to determine. if predetermined constraints on operation of said boiler are violated as a result of said predetermined change in said value of said one or more selected combustion related manipulate variables.

10. The computer program product of claim 2 further comprising computer usable code configured to map for each of said one or more burners in said group of burners and each of said one or more burners in said one or more other groups of burners said associated CI resulting from each of said controlled changes in said one or more selected combustion related manipulate variables when said CI has reached a steady state versus said one or more selected combustion related manipulate variables.

11. The computer program product of claim 10 further comprising computer usable code configured to use said map for each of said one or more burners in said group of burners and each of said one or more burners in said one or more other groups of burners to achieve said associated maximum value of CI.

12. The computer program product of claim 2 further comprising computer usable code configured to allow said tuned combustion for all of said one or more burners in said group of burners and all of said one or more burners in said one or more other groups of burners to be changed to achieve other than said associated maximum value of CI for each of said one or more burners in said group of burners and each of said one or more burners in said one or more other groups of burners.

13. The computer program product of claim 2 wherein each of said one or more selected combustion related manipulate variables has a value for said group of burners and for each of said other groups of burners in said one or more other groups of burners corresponding to said combustion for all of said one or more burners in said group of burners and all of said one or more burners in each of said one or more other groups of burner that achieves said associated value of CI and said computer program product further comprises computer usable code configured to allow said value to be changed for a selected one of said group of burners or one of said other groups of burners in said one or more other groups of burners by a predetermined amount in order to achieve a predetermined optimal objective value for operation of said boiler.

14. A system for optimizing fossil fuel fired burner combustion in a boiler, said boiler comprising one or more burners arranged in a group of burners, comprising:
a computing device having therein program code usable by said computing device, said program code configured to:
permit for each of said one or more burners in said group of burners one or more combustion related manipulate variables to be selected for use in tuning the combustion of each of said one or more burners;
provide a combustion index (CI) for each of said one or more burners; and
use said CI and controlled changes in said one or more selected combustion related manipulate variables to tune the combustion of each of said one or more burners in said group of burners so that each of said one or more burners in said group achieves an associated maximum value of CI.

15. The system of claim 14 wherein said boiler further comprises one or more other group of burners, each of said other group of burners having one or more burners, and program code usable by said computer is further configured to:
to permit for each of said one or more burners in said one or more other groups of burners one or more combustion related manipulate variables to be selected for use in tuning the combustion of each of said one or more burners in each of said one or more other groups;
provide a CI for each of said one or more burners in each of said one or more other groups; and
use said CI and controlled changes in said one or more selected combustion related manipulate variables to tune the combustion of each of said one or more burners in each of said one or more other groups so that each of said one or more burners in said one or more other groups achieves an associated maximum value of CI.

16. The system of claim 14 wherein said program code usable by said computer is further configured to: determine for each of said one or more burners a value of said CI that corresponds to a desired level of controlled emissions from said fossil fuel fired boiler.

17. The system of claim 15 wherein said program code usable by said computer is further configured to:
determine for each of said one or more burners in said group of burners and each of said one or more burners in said other groups of burners a value of said CI that corresponds to a desired level of controlled emissions from said fossil fuel fired boiler.

18. The system of claim 14 wherein said program code usable by said computer is further configured to:
allow said tuned combustion for all of said one or more burners in said group of burners to be changed to achieve other than said associated maximum value of CI for each of said one or more burners.

19. The system of claim 15 wherein said program code usable by said computer is further configured to:
allow said tuned combustion for all of said one or more burners in said group of burners and all of said one or more burners in said one or more other groups of burners to be changed to achieve other than said associated maximum value of CI for each of said one or more burners in said group of burners and each of said one or more burners in said one or more other groups of burners.

20. The system of claim 14 wherein each of said one or more selected combustion related manipulate variables has a value for said group of burners corresponding to said combustion for all of said one or more burners in said group that achieves said associated value of CI and said program code usable by said computer is further configured to:
allow said value to be changed by a predetermined amount in order to achieve a predetermined optimal objective value for operation of said boiler.

21. The system of claim 15 wherein each of said one or more selected combustion related manipulate variables has a value for said group of burners and for each of said other groups of burners in said one or more other groups of burners corresponding to said combustion for all of said one or more burners in said group of burners and all of said one or more burners in each of said one or more other groups of burner that achieves said associated value of CI and said program code usable by said computer is further configured to:
allow said value to be changed by a predetermined amount in order to achieve a predetermined optimal objective value for operation of said boiler.

22. A computer program product for optimizing combustion in a fossil fuel fired boiler having two or more groups of burners, each of said two or more groups of burners having one or more burners, said computer program product comprising:
computer usable program code configured to permit for each of said one or more burners in said two or more groups of burners one or more combustion related manipulate variables to be selected for use in tuning the combustion of each of said one or more burners in each of said two or more groups of burners;
computer usable program code configured to provide a CI for each of said one or more burners in each of said two or more groups of burners; and
computer usable program code configured to use said CI and controlled changes in said one or more selected combustion related manipulate variables to tune the combustion of each of said one or more burners in each of said two or more groups of burners so that each of said one or more burners in said two or more groups of burners achieves an associated maximum value of CI.

23. The computer program product of claim 22 wherein each of said one or more selected combustion related manipulate variables has an associated value for each of said two or more groups of burners corresponding to said combustion for all of said one or more burners in each of said two or more groups of burners that achieves said associated value of CI and said computer program product further comprises computer usable code configured to allow said value to be changed for a selected one of said two or more groups of burners by a predetermined amount in order to achieve a predetermined optimal objective value for operation of said boiler and to determine if predetermined constraints on operation of said boiler are violated as a result of said predetermined change in said associated value of said one or more selected combustion related variables for said selected one of said two or more groups of burners.

24. The computer program product of claim 23 further comprising computer usable code configured to restore said value for each of said one or more selected combustion related manipulate variables for said selected one of said two or more groups of burners to said associated value that achieves said associated values of CI when said associated value is to be changed for another selected one of said two or more groups of burners and to determine if predetermined constraints on operation of said boiler are violated as a result of said predetermined change in said associated value of said one or more selected combustion related variables for said another selected one of said two or more groups of burners.
